(19) United States
(12) Patent Application Publication
(10) Pub. No.: US 2005/0000153 A1
(43) Pub. Date: Jan. 6, 2005

(54) Micro maple spout and method of use

(76) Inventors: Robert A. White, Underhill, VT (US); Harold R. Torre, Milton, VT (US)

Correspondence Address: Law Offices Eric R. Benson, Esq., Box 65238, Champlain Station, Burlington, VT, 05406-5238, US

(21) Appl. No.: 10/867,895

(22) Filed: Jun. 15, 2004

Related U.S. Application Data
(60) Provisional application No. 60/480,754, filed on Jun. 23, 2003.

(51) Int. Cl. A01G 23/10; A01G 23/14

(52) U.S. Cl. 47/11

(57) ABSTRACT

A Micro Maple Spout and Method of Use made of rigid bacteria resistant materials that is significantly smaller than the current industry standard. The small size and nature of the construction materials of the Micro Maple Spout allows the collection tubing to be slid on and off instead of being permanently attached. The concomitant smaller tap hole in the sap trees results in far less sap tree damage than current designs and further results in significantly increased production of maple sap. One embodiment of the invention allows the use of smaller and less expensive collection tubing than the current industry standard and in yet another embodiment the Micro Maple Spout may be retro-fitted to existing prior art spouts.

### BACKGROUND ART

The tapping of maple trees to gather its sap by use of spouts is well known in the art and the seminal technology likely pre-dates the U.S. patent system. The current art practice for collecting maple sap involves drilling a hole in each tree with a drill sized either 0.298″, 0.312″ or 0.4375″ (inches), all of which are common maple sugaring industry standards. The drilled holes would then be tapped with a spout with an outside diameter that is slightly larger than the respective drilled hole to form a snug fit as the spout is driven into the drilled hole.

The standard in the industry for well over 100 years was the 0.4375″ (inch) diameter holes that were drilled about 2 inches deep and then tapped with a spout with an outside diameter that is slightly larger than the 0.4375″ drilled hole. The maple sugaring industry, however, had a long felt need for a smaller tap that would still allow for the free flow of sap while minimizing the damage to the tree caused by the drilling of a relatively large hole in the sap tree. It is not uncommon in the industry for trees that have been tapped by use of 0.4375″ drilled holes to require a full twenty (20) or more years to heal. In some cases the trees are unable ever to heal over such an invasive boring into the cambium of the tree.

The 0.298″ tap hole standard was introduced to the maple sugaring industry in about 1998. Canadian patent number CA2233739, (Jean-Marie Chabot Jan. 10, 2000) introduced to the industry with great success taps that fit snugly into 0.298″ diameter drilled holes. The Chabot patent rapidly became the industry standard as tree wounding was significantly reduced with no production losses. The experience in the sugaring industry with the spouts that utilize the 0.298″ diameter drilled holes, however, even though they are almost one-half the size of the 0.4375″ drilled holes, is the long term damage and healing required from what remains a very invasive hole that is bored into the tree. It is not uncommon for trees that have been tapped in this manner to still require years to heal.

The most commonly used maple tree spouts by large producers in the industry today are permanently attached to tubing collection systems. For instance, Canadian Patent No. 1,158,868 (Foote, et al. Dec. 20, 1983) and Canadian Patent No. 1,227,043 (Lamb Sep. 22, 1987) both teach collecting lines that pump sap from the tapped trees to a central collection means. These tubing collection systems utilize either gravity or suction by a vacuum pump to collect the sap as it flows out of the tree through the spout into the tubing and on to a collection vessel ready for boiling into maple syrup.

All standard maple sugaring industry spouts used in vacuum systems are made from plastic. Because these spouts are made of plastic and are generally, in whole or part, permanently attached to the tubing collection system this allows for bacterial growth and other undesirable problems, such as destruction by rodents i.e. squirrels, as they remain in the environment when not in use an average of nine (9) months out of the year. U.S. Pat. No. 6,438,895 describes a partially removable Spout feature, which is only a partial improvement over the prior art. The design is complex and difficult to use especially when applied to large scale maple operations with thousands of spouts. This device also leaves a portion of the spout in the environment during the off season, subject to bacterial contamination and rodent destruction.

Prior art spouts often have annular ring surfaces protruding up from the base of the tapered outside edge of the tap portion to allow the spout to seat into the tree, and there are also notches cut into the end of the spouts. These annular ring surfaces and notches allow bacteria and other foreign material to build up on the spouts. Bacterial contamination has the potential of ruining the sap collected and/or causing the tree to stop running sap into the contaminated spout. None of the prior art completely addresses this problem, leaving bacterial contamination and rodent destruction of spouts as a leading problem among maple sugar producers.

A common industry wide problem with the use of prior art spouts is selecting the date for tapping the trees in the sugarbush. If the date of tapping is too early the tap holes will start to heal over preventing sap from flowing into the tap and out the spout before the sap in the trees stops running. If the date of tapping is too late the producer can miss a large portion of the season when the sap first begins running.

Once a tree is tapped the current industry practice is to leave the prior art and spouts in place for the season. Reboring the same hole to a slightly larger diameter from the prior art hole sizes has proven ineffective in improving sap production during the season because the parenchyma a round hole in its healing process will generally inhibit or prevent any sap from running in a fairly substantial area of the tree surrounding the drilled hole. Tapping new fresh holes elsewhere on the same tree is generally not practiced due to the additional tree wounding prior art large spouts cause.

Maple sap harvesting has rapidly evolved over the last ten years. For instance, just ten years ago, the average production expected from a single average maple tree was about 2.75 pounds per Spout. Production levels tend to vary widely from year to year. Using vacuum systems and the 0.298″ Spouts, as are prevalent in the current prior art methods, production levels often have risen to about 5 pounds per Spout and this production level is much more consistent year to year than previously used prior art devices and methods.

While each of these prior art maple tree spouts fulfill their respective particular objectives and requirements, and are most likely quite functional for their intended purposes, it will be noticed that none of the prior art cited disclose an apparatus and/or method that allows the user to completely remove all components of the spout while not in use, and is composed of bacterial resistant materials. Also, the prior art spouts still require a relatively large hole to be drilled into the sap tree which is harmful to the health of the tree and has a negative impact on the amount of sap collected from the spout due to the healing over of the hole by the sap tree.

As such, there apparently still exists the need for new and improved micro maple Spout and method of use to maximize the benefits to the user in the form of sap production and minimize the risks of injury to the sap tress from its use.

In this respect, the present invention disclosed herein substantially corrects these problems and fulfills the need for such a device.

### DISCLOSURE OF THE INVENTION

In view of the foregoing limitations inherent in the known types of maple spouts and methods of use now present in the prior art, the present invention provides an apparatus that has been designed to provide the following features for a user:
a spout that is much smaller in size, compared to current industry standards, allowing for a smaller hole to be drilled in the sap tree for its placement and therefore causing far less tree tap hole wounding;
increased sap production resulting from use of the smaller Spout size which results from the tapped hole staying open longer;
a spout that has an easy slip on design for installing and removing the spout from the tubing collection system, or inserting into prior art spouts to allow the prior art spout tap end to be reduced in size, thus requiring a smaller hole be drilled in the sap tree;
a further feature of the present design is to allow for a management practice to be used to increase production in tapping maple trees that has not been practical when using larger prior art designs.
a spout that has V grooved annular rings cut into the spout taper to help the spout seat into the tree.
a spout with V grooved annular rings that are self cleaning having no surface upon which bacteria or undesired material will adhere to.
a spout that is durable and resistant to destruction by rodents, such as squirrels.

These features are improvements which are patently distinct over similar devices and methods which may already be patented or commercially available. As such, the general purpose of the present invention, which will be described subsequently in greater detail, is to provide a field designed apparatus and method of use that incorporates the present invention. There are many additional novel features directed to solving problems not addressed in the prior art.

These together with other objects of the invention, along with the various features of novelty which characterize the invention, will be pointed out with particularity in the claims. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

FIG. 1 is a graphic depiction of the number of gallons of sap per tap per season collected in a study comparing the present invention with prior art spouts.

FIG. 2 is a side view of the preferred embodiment of the present invention with hidden lines depicting the internal channel through which maple sap will travel.

FIG. 3 is a collection end view of the preferred embodiment of the present invention with hidden lines depicting the outside diameter of the barrel portion of the present invention.

FIG. 4 is a side view of the small-tube collection embodiment of the present invention with hidden lines depicting the internal channel through which maple sap will travel.

FIG. 5 is a side view of the retro-fit embodiment of the present invention with hidden lines depicting the internal channel through which maple sap will travel.

FIG. 6 is a side view of the prior art current industry standard maple Spout with hidden lines depicting the internal channel through which maple sap will travel.

FIG. 7 is a side view of the retro-fit embodiment of the present invention of FIG. 5 connected to the prior art current industry standard maple spout of FIG. 6.

### BEST MODES FOR CARRYING OUT THE INVENTION

I. Preferred Embodiments

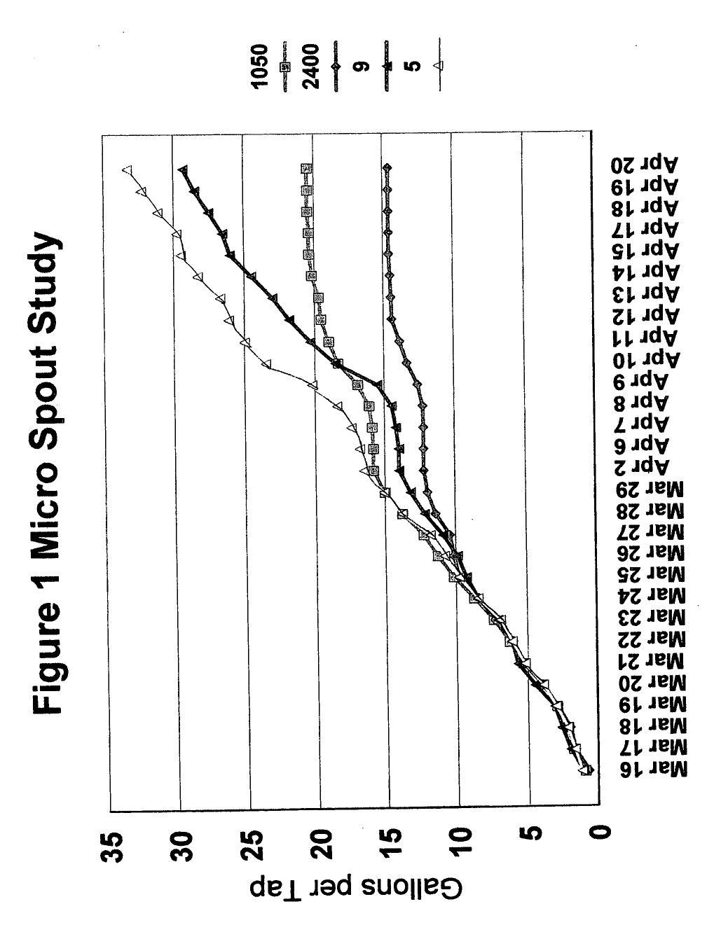

With reference now to the drawings, and in particular to FIGS. 1-6 thereof, a new and novel apparatus and method of use for a Micro Maple Spout embodying the principles and concepts of the present invention is depicted in these drawings as principally comprising a one piece design and is generally designated by the reference numerals 10 in the Preferred Embodiment, 20 in the Small-tube Collection Embodiment and 30 in the Retro-fit Embodiment.

General Description of Reference Numerals in the Description and Drawings

Any actual dimensions listed are those of the preferred embodiment. Actual dimensions or exact hardware details and means may vary in a final product or most preferred embodiment and should be considered means for so as not to narrow the claims of the patent.

List and Description of Component Parts of the Invention:

(1) Tap Taper
(2) Hose Coupler
(3) Spout Barrel
(4) Tap Nose
(5) Sap Channel
(6) Annular V Grooves
(10) Preferred Embodiment
(20) Small-tube Collection Embodiment
(22) Small-tube Hose Coupler
(30) Retro-fit Embodiment
(32) Retro-fit Tap Insert End
(40) Prior Art Spout
(42) Prior Art Hose Coupler
(44) Prior Art Tap Nose
(45) Prior Art Sap Channel
   Detailed Description of the Preferred Embodiments:

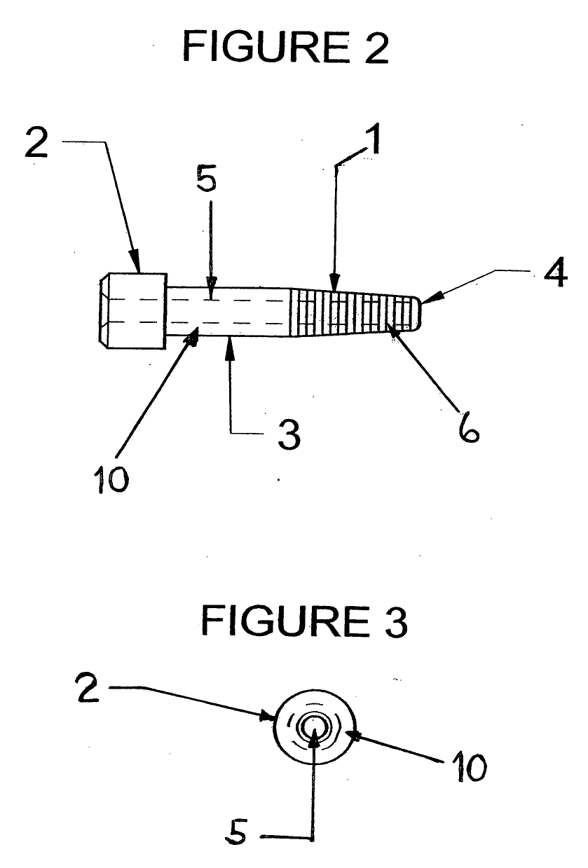

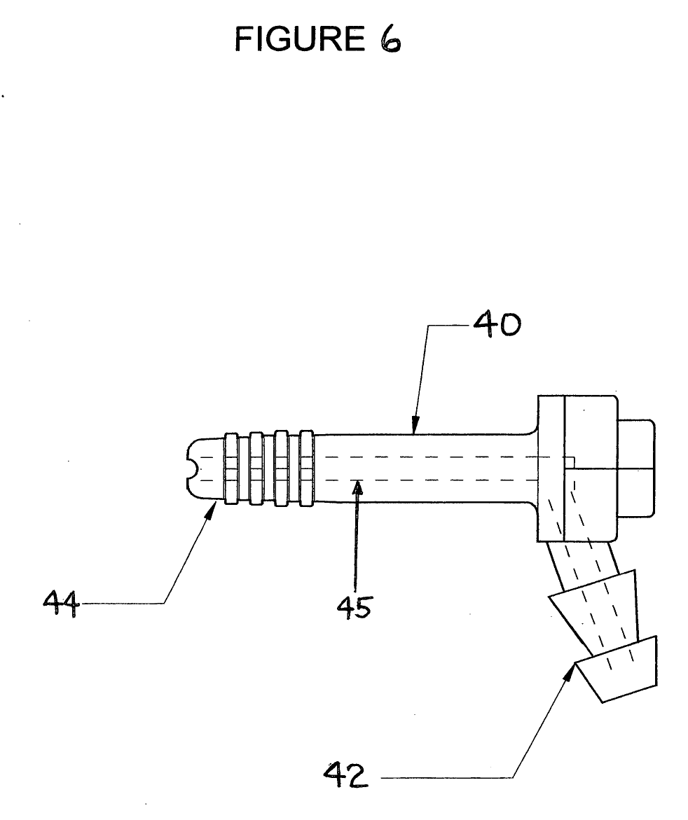

FIG. 1 depicts the results of extensive production research conducted during the 2003 maple production season comparing the Preferred Embodiment 10 of the present invention as depicted in FIGS. 2 and 3 with the Prior Art Spout 40 depicted in FIG. 6. Multiple designs were manufactured for testing taking into consideration commercial viability and potential high volume manufacturing costs. Testing was completed in a commercial maple production operation with 3450 spouts being placed. These 3450 taps were divided into 4 groups.

A total of seventy-five (75) of the Preferred Embodiment 10 Micro Spouts were compared and tested against 3 types of taps generally resembling the Prior Art Spout 40 depicted in FIG. 6 for a total of 3375 of said prior art spouts. The production results are described in FIG. 1 and are therein delineated as gallons of sap produced per day.

The legend for FIG. 1 is as follows:

2400 describes the main sugarbush, which had twenty-four hundred (2,400) 0.298″ Prior Art Tap(s) and Spout(s) 40 placed by tapping in mature trees. The location of this main sugarbush is a warm hillside site with full sunlight.
1050 describes another sugarbush on a cooler hillside which had one thousand fifty (1050) 0.298″ Prior Art Spout 40 placed by tapping in young trees ranging in diameter from 9 to 14 inches in size.
9 describes a group of seven (7) trees that had nine (9) of the Preferred Embodiment 10 Micro Spouts wherein the sap was collected in one vacuum chamber. These trees were known poor producers from past production history when tapped with buckets. These nine trees ranged in size from 12 to 18 inches in diameter.
5 describes a group of five (5) trees with the Preferred Embodiment 10 Micro Spouts that were individually monitored and collected. These five trees ranged in size and number from two 14 inch diameter trees, one 16 inch diameter tree, one 12 inch diameter soft maple, and one very small 12 inch diameter tree. The 16 inch tree was known to be a good producer using prior art spouts and it was a high producer in this study as was expected.
   The study that resulted in the data depicted in FIG. 1 focused on several areas of study which included:
   1. Potential Construction Materials (what is the preferred composition of material)
   2. Potential Hole Size and Depth (tree wounding issues involve both diameter and depth of the bored tap hole)
   3. Ease of use and time required per tap (maple sugaring is a labor intensive industry, therefore ease of use was a critical study element)
   4. Vacuum Effects (most major sugaring operations utilize vacuum collection systems, therefore study of the use of vacuum systems with the present invention was also critical)
   5. Early Season and Daily Production and Effects (Temperature and tree health can radically affect production of maple sap, therefore the daily monitoring of production was very important in assessing the benefits of the present invention)
   6. Annual Production and Effects (Overall production for a season is the most critical test of the benefit of this invention)
   7. Late season tapping practices (maple sap producers are always looking to maximize the “season” for sap production, therefore the present invention's end of season production was very important to study)
   8. Cleaning operation (bacteria is the nemesis of the maple producer and comprehensive study was critical in the area of cleaning and preventing bacterial contamination)
   9. Tap Hole Healing (it is well known in the art that tap hole healing is in part what causes the sap to stop running and also affects the overall health of the tapped tree, therefore the study of the present invention's affect on the tree and the healing of its tap hole was very important)
   10. Potential management practice changes

Examining each of these areas specifically it was concluded as follows:

1. Potential Construction Materials

Many types of construction materials to make the present invention were considered. The Prior Art Spout 40 depicted in FIG. 6 is generally made of injection molded plastic which was determined to be to weak for use in the present invention Preferred Embodiment 10, with currently available plastics.

Brass was used for prototypes but since there is no easy way to ensure with brass that there will be no lead entering into the sap, the use of brass was rejected because a maple Spout must be made of food grade material with no risk of lead leaching into the sap.

Stainless steel was selected and became the best option for several reasons, including strength, usable life, and a lack of any negative environmental effects. Stainless steel does have a higher manufacturing cost, but the benefits and increased production far outweighed the additional cost.

2. Potential Hole Size and Depth

The tap holes in trees necessary to accommodate the Prior Art Spout 40 depicted in FIG. 6 are generally 0.296″, 0.312″ or 0.435″ (inches) in diameter. Testing the theorem that a smaller tap hole would both increase production and reduce damage to the tapped trees the study focused on using the smallest tap hole size that a usable and durable Spout could still be manufactured. The spout would also have to be rugged enough to handle the current maple industry demands. Initially 0.140″ holes were used, but later it was found that the tested spouts would fit into 0.125″ holes. After extensive testing it was determined that 0.136″ should be the micro spout standard for the Preferred Embodiment 10.

Prior Art Spout 40 depicted in FIG. 6 generally necessitate a tap hole depth of about 1.5″ to 2″ deep into the tree being tapped. The Preferred Embodiment 10, however, only requires that the hole be drilled to a 1″ depth. The 1″ depth worked out far better than was expected and is the recommended depth of drilling. Using 0.125″ diameter holes with a 1″ hole depth removes about 85% less wood than the Prior Art Spout 40 depicted in FIG. 6. This will have a major impact in reducing tree wounding and improving tap range health of the tree.

Current testing of 0.060″ spouts is underway and the results are also impressive, leading to an even smaller degree of wounding of trees.

3. Ease of Use and Time Required Per Tap

Prior Art Spout 40 depicted in FIG. 6 are generally permanently attached to tubing at each tree. Working with the Preferred Embodiment 10, the small-tube collection embodiment 20 and the retro-fit embodiment 30 there was no loss in time or increase in effort necessitated by use of these embodiments of the present invention over the Prior Art Spout 40 depicted in FIG. 6. However, during the season the present invention took no time to maintain, while the Prior Art Spout 40 depicted in FIG. 6 took extensive maintenance time due to Vacuum Leaks.

4. Vacuum Effects

There are two potential vacuum leak points on any type of Spout, i.e. the tree seal and the tubing seal. The seal has to be able to hold at least 20 inches of vacuum. Initially both the Prior Art Spout 40 depicted in FIG. 6 and the Preferred Embodiment 10 had no problem holding this amount of vacuum. However, the Prior Art Spout 40 depicted in FIG. 6 had a high rate of leakage at the tree seal after several freeze and thaw cycles. the stainless steel Preferred Embodiment 10 had no tree seal leaks during the season. It is believed that the combination of the smaller (tree drilled) hole size, the Annular V Grooves' 6 superior seals and the position of the seals on the Tap Taper 1 collectively provide for a vacuum seal to the tree that is superior to the Prior Art Spout 40 depicted in FIG. 6.

5. Early Season Daily Production and Effects

In the early part of the season (about March 16th to April 9) the four measured groups utilizing the Preferred Embodiment 10 as compared to the Prior Art Spout 40 depicted in FIG. 6 produced about the same amount of sap per tap hole.

6. Annual Production and Effects

The data reflected in FIG. 1 is the result of a research project which took eight years of work to put in motion. With more than twenty-five years experience in the maple sugaring industry the results at the end of the production season were totally unexpected. As the data in FIG. 1 reflects the Prior Art Spout 40 depicted in FIG. 6 tap holes were far more effected by the warmer temperatures than were the tap holes of the Preferred Embodiment 10. Sap production in the 0.298″ tap holes of the Prior Art Spout 40 depicted in FIG. 6 slowed down and stopped completely, while the 0.140″ tap holes of the Preferred Embodiment 10 continued to produce until the trees stopped running about April 20. The research found that the warmest area of the woods was far more effected by these positive results than the cooler area. This is depicted in the production data in FIG. 1 in comparing 2400 in FIG. 1 which is our warmest site to 1050 in FIG. 1 which is a cooler hillside facing away from direct sunlight. This effect allowed the Preferred Embodiment 10 to far out-produce the Prior Art Tap(s) and Spout(s) 40 depicted in FIG. 6 in the production year 2003. In all the different locations that the Preferred Embodiment 10 was placed the same increased production effect was experienced.

7. Late Season Tapping Practices

Once the 0.298″ tap holes of the Prior Art Spout 40 depicted in FIG. 6 stopped producing the Preferred Embodiment 10 spouts continued to run. Several tests were run to determine if there were potential tapping practices that would be advantageous to change if only Preferred Embodiment 10 spouts were used and the following was found:

Reboring the dried up tap hole which has been attempted by many producers is useless as the tree healing process has shut down the sap flow to all areas directly around the tap hole. This was tested by drilling micro holes at several angles inside an existing dried up tap hole and very little additional sap was produced thereby. When a new hole was drilled to tap with the Preferred Embodiment 10 just a few inches away a large volume production of sap resulted that ran to the end of the season.

With the Prior Art Spout 40 depicted in FIG. 6 larger tap holes it would be unwise to put additional stress on the tree by making an additional tap hole in the same season. The research undertaken with the Preferred Embodiment 10 spouts indicated that if a prior drilled tap hole did dry up at some point during the season the same tree may be retapped in another location with little to no negative affect on the tree. This result has the potential of becoming a significant management practice change over current methods of maple sugaring that can help stabilize production levels from year to year regardless of the effects seasonal temperature differentials may place upon the maple trees. Unlike the sap flows experienced, as shown in FIG. 1, using Prior Art Spout 40 depicted in FIG. 6 in the 2400 and 1050 tapped trees the research data as depicted in FIG. 1 demonstrates that good quality sap flow continued until April 28th with the Preferred Embodiment as opposed to the Prior Art Spout 40 depicted in FIG. 6 which stopped producing almost three weeks earlier. Virtually all production from the Prior Art Spout 40 depicted in FIG. 6 ceased by the first week of April, a fairly common date each year for these larger Prior Art Spout 40 depicted in FIG. 6.

8. Cleaning Operation

The high sap production data depicted in FIG. 1 is in part attributable to the ability to clean and maintain virtually bacteria free the Preferred Embodiment 10 which in turn also decreases cleaning time and effort because the rings of the Annular V Grooves 6 tend to clean themselves after the season. Residual material clings to the Prior Art Spout 40 depicted in FIG. 6 which leads to bacterial contamination and a ruining of the spout. Unlike all prior art spouts, the residual material generally dries out and falls off easily from the Preferred Embodiment 10. Therefore, no manual brush cleaning is required. The Preferred Embodiment can then easily be sterilized in a dish washer just prior to the next season's use.

9. Tap Hole Healing

With the use of 0.435″ tap holes the trees required several years to heal, and had remained badly scarred for many years. Very often these tree wounds lead to a cracking of many trees yielding permanent damage and premature death of the affected trees. Using the Prior Art Spout 40 depicted in FIG. 6 with 0.298″ tap holes, however, approximately 50% of the tapped trees heal in one subsequent season while the majority of the rest require another year to heal. The scarring is less visible than that caused by the 0.435″ tap holes and most scars require three or more years to completely heal over.

With the Preferred Embodiment 10 0.125″ tap holes most of the tapped trees are healed in about a month. Any scarring that may occur is very difficult to find the following season.

10. Potential Management Practice Changes

The use of the Preferred Embodiment provides sugarbush management options that do not exist with the use of the Prior Art Spout 40 depicted in FIG. 6. The research data and testing depicted in FIG. 1 have given rise to management methods unknown in the prior art that include:
moving tap(s) as needed during the season, based on measured daily sap production changes, tree temperature factors, and time necessary to move the tap(s).
placing two spouts on each tree, one for early production, one for late season production.
installing two completely separate systems for collecting sap, one for early production the other for late, which allows for superior quality syrups in the late season.

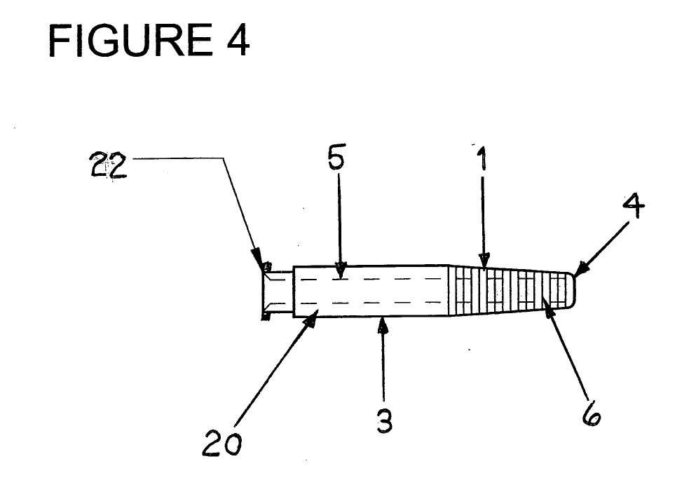

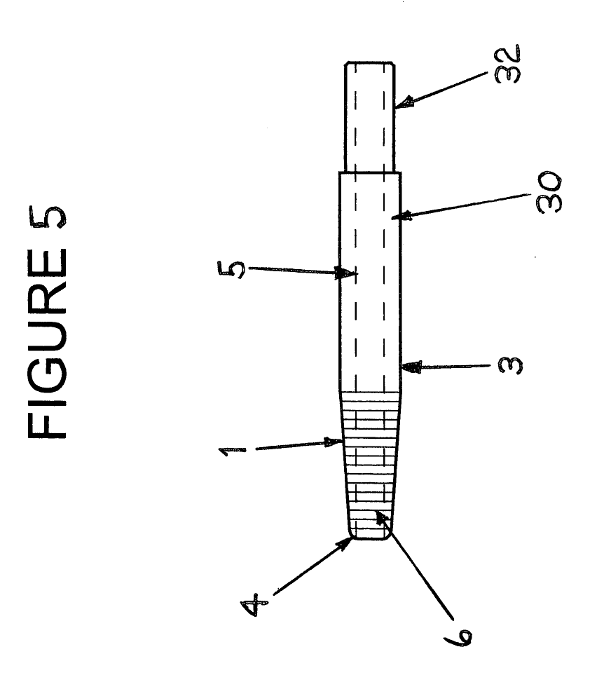

The Preferred Embodiment 10 as depicted in FIGS. 2 and 3, the Small-tube Collection Embodiment 20 depicted in FIG. 4 and the Retro-fit Embodiment 30 depicted in FIG. 5 are preferably made from machined stainless steel. It would be obvious to anyone skilled in the art that these embodiments could be made from any suitable material. Each of these three embodiments have a Tap Taper 1, a Spout Barrel 3, a Tap Nose 4, a Sap Channel 5 and a set of Annular V Grooves 6.

The Tap Taper 1 works best between a 2% to 8% gradient from the Tap Nose 4 to the Spout Barrel 5 and is cut or cast with Annular V Grooves 6 that are cut or cast in the Tap Taper 1 and are between 0.010″ and 0.025″ wide. The length of the Tap Taper 1 in each of the three embodiments is approximately 0.3″ to 0.7″ long. The outside diameter (OD) of the Tap Nose 4 may range in size from 0.040″ to 0.21874″ and the OD of the Spout Barrel 5 may range in OD size from 0.140″ to 0.31874″ and will vary in length depending upon the thickness of the bark of the trees sought to be tapped. The tree to be tapped is drilled with a hole that is just slightly larger than the OD of the Tap Nose 4. This drilled hole may range in depth from about 1″ to 2″ deep depending upon the thickness of the bark of the tree which can range from 0.10″ to 1″ thick or more depending upon the age and species of the sap tree being tapped.

The Tap Nose 4 is blunt by design so that as the three embodiments are driven into the hole drilled in the sap tree the Tap Nose 4 will automatically center the embodiments in the hole and create a vacuum tight seal in the sap tree as the Annular V Grooves 6 securely hold each of the three embodiments in the holes that are drilled into the sap tree. In all three embodiments once driven into place in the drilled hole in the sap tree, sap will run from the tree into the Sap Channel 5 from the Tap Nose 4 to the opposite or spout end containing the collection means.

In the Preferred Embodiment 10 depicted in FIGS. 1 and 2 the inside diameter (ID) of a hose is connected securely over the outside diameter (OD) of the Hose Coupler 2 and the sap flowing through the Sap Channel 5 exits the Sap Channel 5 and is collected inside the hose that is connected to the Hose Coupler 2. The sap then runs in the hose aided by either gravity alone or by being vacuum pumped to a collection point for processing into maple syrup. The Hose Coupler 2 is designed to provide a snug friction fit for standard tubing in the sugaring industry that permits the user to remove the spout of the Preferred Embodiment 10 relatively easily at the end of a season. The hose may also be secured to the Hose Coupler 2 by means of a clamp or a clip.

In the Small-tube Collection Embodiment 20 depicted in FIG. 4 the inside diameter (ID) of a smaller and less expensive than industry standard hose is connected securely over the outside diameter (OD) of the Small-tube Hose Coupler 22 and the sap flowing through the Sap Channel 5 exits the Sap Channel 5 and is collected inside the hose that is connected to the Small-tube Hose Coupler 22. The sap then runs in the hose aided by either gravity alone or by being vacuum pumped to a collection point for processing into maple syrup. The Small-tube Hose Coupler 22 is designed to provide a snug friction fit for standard tubing in the sugaring industry that permits the user to remove the spout of the Small-tube Collection Embodiment 20 depicted in FIG. 4 relatively easily at the end of a season. The hose may also be secured to the Small-tube Hose Coupler 22 by means of a clamp or a clip.

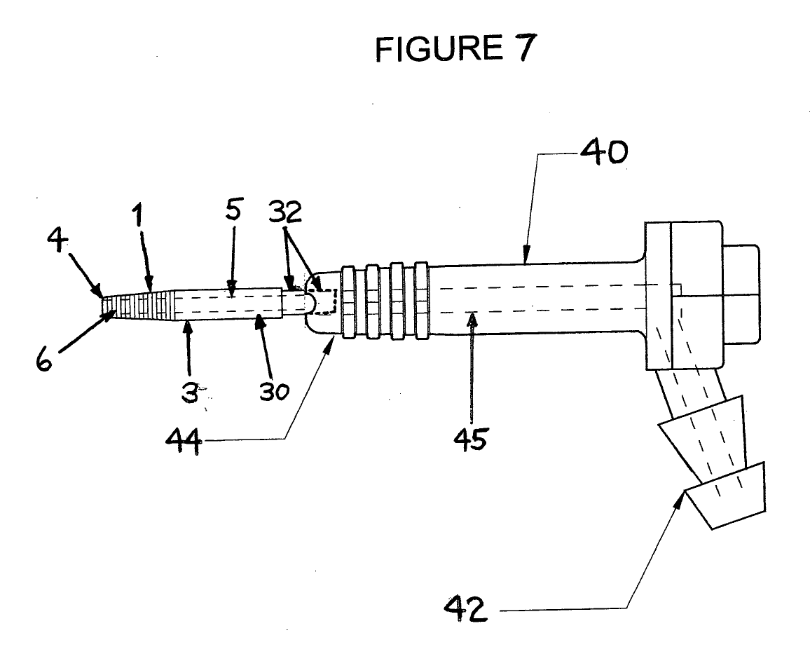

To use the Retro-fit Collection Embodiment 30 depicted in FIG. 5 the inside diameter (ID) of the Prior Art Tap Nose 44 is connected securely in a vacuum tight seal over the outside diameter (OD) of the Retro-fit Tap Insert End 32 as depicted in FIG. 7 and the sap flowing through the Sap Channel 5 exits the Sap Channel 5 and then runs into the Prior Art Sap Channel 45. The sap then runs through the Prior Art Hose Coupler 42 into a hose aided by either gravity alone or by being vacuum pumped to a collection point for processing into maple syrup. The Retro-fit Tap Insert End 32 is designed to provide a snug friction fit for the tap end of standard Prior Art Taps 40 used in the sugaring industry that permits the user to remove the spout of the Retro-fit Collection Embodiment 30 depicted in FIG. 7 relatively easily at the end of a season.

While my above descriptions of the invention, its parts, and operations contains many specificities, these should not be construed as limitations on the scope of the invention or its method of use, but rather as exemplifications of present embodiments thereof. Many other variations are possible, for example, other embodiments, shapes, composition of materials and sizes of the device can be constructed to work by the principles of the present invention; various materials, colors and configurations can be employed in the unit's design that would provide interesting embodiment differences to users.

Accordingly, the scope of the invention should be determined not by the embodiments illustrated, but by the claims and their legal equivalents as filed herewith.

1. A spout for collecting sap from a tapped hole of a tree being comprised of:
a spout barrel;
the spout barrel wherein the outside diameter of the spout barrel is at least 0.140 inches in diameter and no more than 0.31874 inches in diameter;
the spout being further comprised of a tapered tap end and a sap delivery end with the spout barrel there between;
the spout being further comprised of a sap channel running completely through the tapered tap end then through the spout barrel and then through the sap delivery end;
the tapered tap end having a tap nose at the complete opposite end of the spout from the sap delivery end wherein the outside diameter of the tap nose is smaller in diameter than the outside diameter of the spout barrel and the tap nose is at least 0.040 inches in diameter and no more than 0.275 inches in diameter;
the tapered tap end having an attachment means;
the tapered tap end being tapered up in diameter from the smaller outside diameter of the tap nose to the larger outside diameter of the spout barrel such that when the tapered tap end is placed in the tapped hole of a tree the spout is held in place by the attachment means thereby causing the sap from the tree to enter into the sap channel from the tapered tap end of the spout barrel where it is conducted by a sap transport means through the sap channel of the spout barrel to the sap delivery end of the spout barrel where the sap is collected by the user;

2. The spout for collecting sap from a tapped hole of a tree of claim 1 wherein the spout is made from one or more rigid bacteria resistant materials.

3. The spout for collecting sap from a tapped hole of a tree of claim 1 wherein the attachment means is one or more annular grooves attached to the gradient of the tapered tap end of the spout in a generally perpendicular position relative to the plane of the portion of the sap channel that runs through the tapered tap end of the spout.

4. The spout for collecting sap from a tapped hole of a tree of claim 1 wherein the sap transport means is gravity.

5. The spout for collecting sap from a tapped hole of a tree of claim 1 wherein the sap transport means is capillary action.

6. The spout for collecting sap from a tapped hole of a tree of claim 1 wherein the sap transport means is a vacuum hose.

7. The spout for collecting sap from a tapped hole of a tree of claim 1 wherein the sap transport means is a siphon hose.

8. The spout for collecting sap from a tapped hole of a tree of claim 1 wherein the sap delivery end has an outside diameter capable of fitting securely by friction in the inside diameter of current commercially available tree taps.

9. The spout for collecting sap from a tapped hole of a tree of claim 1 wherein the sap delivery end has an outside diameter capable of fitting securely in the inside diameter of commercially available tubing.

10. The spout for collecting sap from a tapped hole of a tree of claim 1 wherein the sap delivery end is further comprised of a bucket holding means such that a bucket held by the bucket holding means will contain the sap from the tree as it exits the spout from the sap delivery end of the spout.

11. The spout for collecting sap from a tapped hole of a tree of claim 2 wherein the rigid bacteria resistant materials include stainless steel.

12. The spout for collecting sap from a tapped hole of a tree of claim 2 wherein the rigid bacteria resistant materials include plastic.

13. The spout for collecting sap from a tapped hole of a tree of claim 1 wherein the spout is manufactured from at least one disposable material.

14. The spout for collecting sap from a tapped hole of a tree of claim 13 wherein at least one of the disposable materials is plastic.

15. A method of using the spout for collecting sap from a tapped hole of a tree of claim 1 comprising the steps of:
selecting a tree to tap;
drilling at least one hole in the tree such that the drill tip is directed generally toward the center of the tree;
the hole in the tree being drilled to a depth of up to 2 inches depending upon the thickness of the bark of the tree;
the hole in the tree being drilled to a diameter that is slightly larger than the outside diameter of the tap nose;
removably attaching the tapered tap end of the spout to the tree by placing the tap nose of the tapered tap end of the spout in the drilled hole of the tree such that the sap from the tree can only exit the tree via the sap channel;
collecting the sap as it exits the sap channel from the sap delivery end of the spout;
removing the spout from the tree and the sap transport means after the desired sap is collected;
cleaning the spout; and
cleaning the sap transport means.

16. The method of using the spout for collecting sap from a tapped hole of a tree of claim 15 wherein the sap transport means includes attaching a vacuum hose to the sap delivery end of the spout such that the sap that exits the sap channel of the spout is transported by the vacuum hose to a user selected collection means.

17. The method of using the spout for collecting sap from a tapped hole of a tree of claim 15 wherein the sap transport means is gravity and the collecting of sap is accomplished by hanging a bucket underneath the sap delivery end of the spout such that as the sap exits the sap channel the sap is contained within the bucket.

18. The method of using the spout for collecting sap from a tapped hole of a tree of claim 15 wherein the sap transport means is a siphon and the collecting of sap is accomplished by attaching a hose to the sap delivery end of the spout such that as the sap exits the sap channel the sap is conducted by siphon action through the tubing to a user selected collection means.

19. The method of using the spout for collecting sap from a tapped hole of a tree of claim 15 wherein the sap transport means is gravity and the collecting of sap is accomplished by attaching a hose to the sap delivery end of the spout such that as the sap exits the sap channel the sap is conducted by gravity through the tubing to a user selected collection means.

20. The method of using the spout for collecting sap from a tapped hole of a tree of claim 15 wherein the cleaning of the spout comprises the step of washing the spout in a cleaning machine.
